(19) United States
(12) Patent Application Publication
(10) Pub. No.: US 2008/0318103 A1
(43) Pub. Date: Dec. 25, 2008

(54) Fuel Cell System

(76) Inventors: Yoichiro Tsuji, Osaka (JP); Yasuhiro Ueyama, Hyogo (JP); Yusuke Ozaki, Nara (JP); Shinya Kosako, Hyogo (JP)

Correspondence Address: MCDERMOTT WILL & EMERY LLP, 600 13TH STREET, NW, WASHINGTON, DC, 20005-3096, US

(21) Appl. No.: 11/661,123

(22) PCT Filed: Oct. 5, 2005
(86) PCT No.: PCT/JP05/18465

§ 371 Date: Feb. 26, 2007

(30) Foreign Application Priority Data
Oct. 15, 2004 (JP) 2004-301486

(51) Int. Cl. H01M 8/10

(52) U.S. Cl. 429/27; 429/30

(57) ABSTRACT

Provided is a fuel cell system including a polymer electrolyte fuel cell with improved durability, which is capable of suppressing a phenomenon in which a polymer electrolyte membrane is decomposed and degraded. In the fuel cell system including the polymer electrolyte fuel cell including: a membrane electrode assembly including a polymer electrolyte membrane with hydrogen ion conductivity, and a fuel electrode and an oxidant electrode sandwiching the polymer electrolyte membrane; a first separator plate for supplying and discharging a fuel gas to and from the fuel electrode; and a second separator plate for supplying and discharging an oxidant gas to and from the fuel electrode, a metal ion supplying means for supplying metal ions, which are stable in an aqueous solution, to the inside of the membrane electrode assembly in an amount equivalent to 1.0 to 40.0% of the ion exchange group capacity of the polymer electrolyte membrane is disposed.

### TECHNICAL FIELD

The present invention relates to a fuel cell system comprising a polymer electrolyte fuel cell.

### BACKGROUND ART

The conventional polymer electrolyte fuel cell using a polymer electrolyte with cation (hydrogen ion) conductivity generates electric power and heat simultaneously by causing an electrochemical reaction between a fuel gas containing hydrogen and an oxidant gas containing oxygen such as air.

FIG. 7 illustrates a schematic sectional view of an example of a basic configuration of a unit cell to be incorporated in the conventional polymer electrolyte fuel cell. FIG. 8 illustrates a schematic sectional view of an example of a basic configuration of a membrane electrode assembly to be incorporated in a unit cell 100 as illustrated in FIG. 7. As illustrated in FIG. 8, in a membrane electrode assembly 101, a catalyst layer 112 comprising a catalyst body obtained by allowing carbon powder to carry an electrode catalyst (for example, a platinum-based metal catalyst) and a polymer electrolyte with hydrogen ion conductivity is formed on both faces of a polymer electrolyte membrane 111 that selectively transfers hydrogen ions.

Currently, as the polymer electrolyte membrane 111, a polymer electrolyte membrane comprising perfluorocarbon sulfonic acid (for example, Nafion (Trade name) available from E. I. du Pont de Nemours and Company) has been generally used. On the outside surface of the catalyst layer 112, a gas diffusion layer 113 having gas permeability and electron conductivity is formed using, for example, carbon paper with water-repellent treatment applied thereon. An electrode (a fuel electrode or an oxidant electrode) 114 is formed of a combination of the catalyst layer 112 and the gas diffusion layer 113.

The conventional unit cell 100 comprises a membrane electrode assembly 101, gaskets 115 and a pair of separator plates 116. The gaskets 115 are arranged on the peripheries of the electrodes with the polymer electrolyte membrane sandwiched thereby in order to prevent the fuel gas and the oxidant gas from leaking to the outside or from being mixed together. The gaskets are integrated with the electrodes and the polymer electrolyte membrane beforehand. The assembly of these is sometimes called a membrane electrode assembly.

On the outside surfaces of the membrane electrode assembly 101, a pair of the separator plates 116 are arranged for mechanically fixing the membrane electrode assembly 101. On the face of the separator plate 116 in contact with the membrane electrode assembly 101, a gas flow channel 117 for supplying a reactant gas (a fuel gas or an oxidant gas) to the electrode and carrying away a gas containing electrode reaction products or non-reacted reactant gas. Although the gas flow channel 117 may be provided independently of the separator plate 116, a typical process is to form a groove in the surface of the separator plate so that the groove constitutes the gas flow channel as illustrated in FIG. 7.

As mentioned above, by fixing the membrane electrode assembly 101 with a pair of the separator plates 116 and supplying the fuel gas to the gas flow channel on one of the separator plates and supplying the oxidant gas to the gas flow channel on the other one of the separator plates, electromotive force of about 0.7 V to 0.8 V can be generated per one unit cell at a practical current density of several tens to several hundreds mA/cm². However, when the polymer electrolyte fuel cell is used as a power source, a voltage of several volts to several hundreds volts is usually needed. In actual use, therefore, a necessary number of the unit cells are connected in series for use as a stack.

In order to supply the reactant gas to the gas flow channel 117, it is necessary to use a manifold, which is a member for dividing a reactant gas supply pipe into branches corresponding to the number of separator plates to be used, and connecting one end of the branch directly with the gas flow channel on the separator plate. A type of manifold that connects an external pipe for supplying a reactant gas with the separator plate directly is particularly called an external manifold. There is another type of manifold with a simplified structure, which is called an internal manifold. The internal manifold is composed of through holes provided on the separator plates with a gas flow channel formed thereon. The inlet/outlet of the gas flow channel is in communication with the through hole so that the reactant gas can be directly supplied to the gas flow cannel from the through hole.

The gas diffusion layer 113 has the following three main functions: first, a function for diffusing a reactant gas in order to supply the reactant gas uniformly to the electrode catalyst in the catalyst layer 112 from the gas flow channel formed on the separator plate 116 arranged on the outside of the gas diffusion layer 113; secondly, a function for promptly discharging water produced through the reaction in the catalyst layer 112 into the gas flow channel; and thirdly, a function for conducting electrons required for or produced in the reaction. The gas diffusion layer 113 is therefore required to have excellent reactant gas permeability, water dischargeability, and electron conductivity.

In general, in order to provide gas permeability, the gas diffusion layer 113 has been formed using a conductive substrate with a porous structure, the substrate being formed of a material with a developed structure such as carbon fine powder, pore-producing agent, carbon paper or carbon cloth. Moreover, in order to provide water dischargeability, a water-repellent polymer typically exemplified by fluorocarbon resin and the like have been dispersed in the gas diffusion layer 113. Further, in order to provide electron conductivity, the gas diffusion layer 113 has been constituted using an electron conductive material such as carbon fiber, metal fiber or carbon fine powder.

Next, the catalyst layer 112 has the following four main functions: first, a function for supplying a reactant gas supplied from the gas diffusion layer 113 to a reaction site of the catalyst layer 112; secondly, a function for conducting hydrogen ions required for or produced in a reaction on the electrode catalyst; thirdly, a function for conducting electrons required for or produced in the reaction; and fourthly, a function for facilitating the electrode reaction by virtue of an excellent catalyst performance and its large reaction area. The catalyst layer 112 is therefore required to have an excellent reactant gas permeability, hydrogen ion conductivity, electron conductivity and catalyst performance.

In general, as the catalyst layer 112, in order to provide gas permeability, a catalyst layer having a porous structure and a gas flow channel has been formed using carbon fine powder or pore-producing agent having a developed structure. Moreover, in order to provide hydrogen ion permeability, a polymer electrolyte has been dispersed in the vicinities of the electrode catalyst in the catalyst layer 112 to form a hydrogen ion network. Further, in order to provide electron conductivity, an electron conductive material such as carbon fine powder or carbon fiber has been used as a carrier of the electrode catalyst to form an electron channel. Moreover, in order to improve catalyst performance, a catalyst body including carbon fine powder and an electrode catalyst in a form of several-nm-size fine particles carried thereon has been highly dispersed in the catalyst layer 112.

With respect to degradation of durability of the polymer electrolyte fuel cell configured as above, there has been a concern about decomposition of the polymer electrolyte membrane. It has been presumed that decomposition of the polymer electrolyte membrane is induced as a result that hydrogen peroxide generated through a side reaction of oxygen reduction reaction becomes radicals by a reaction expressed by the following formula (1) (for example, Non-Patent Document 1).

H₂O²⁺Fe²⁺+H⁺→.OH+H₂O+Fe³⁺ (1)

Moreover, the Non-Patent Document 1 reports that metal ions such as iron ions act as a catalyst in radical generation. The Non-Patent Document 1 further reports that the metal ions strongly interact with an ion exchange group in the polymer electrolyte membrane, making hydrogen ions discharged from the polymer electrolyte membrane, eventually causing degradation in hydrogen ion conductivity of the polymer electrolyte membrane and decrease in cell voltage.

As a countermeasure to this, Patent Document 1 proposes, for example, a technology in which a catalyst layer is provided in the polymer electrolyte membrane for the purpose of reducing the generation of hydrogen peroxide and radicals that attack the polymer electrolyte membrane and preventing cross leakage of gas as well.

In general, since among the above-mentioned metal ions, some are originally contained in the polymer electrolyte membrane as impurities and some are introduced externally during operation, it has been preferred to reduce the amount of metal ions contained in a fuel cell in order to suppress the above-mentioned degradation in hydrogen ion conductivity of the polymer electrolyte membrane and decrease in cell voltage.

In view of the above, for example, Patent Document 2 proposes a technology to use a separator plate made of metal particularly having high corrosion resistance, since metal ions are eluted from a normal separator plate made of metal, causing damage on the membrane electrode assembly.

### Non-Patent Document 1: Preliminary Report of 10th Fuel Cell Symposium Lecture, P.261

### Patent Document 1: JP 6-103992 A

### Patent Document 2: JP 2000-243408 A

### DISCLOSURE OF THE INVENTION

### Problem to be Solved by the Invention

However, in the aforementioned technology disclosed in Patent Document 1, in view of sufficiently preventing decomposition of a polymer electrolyte membrane in the vicinities of a cathode, there has been a room for improvement: since this technology employs a configuration in which a catalyst layer is provided in the polymer electrolyte membrane, it is impossible to sufficiently suppress generation of peroxide such as hydrogen peroxide and radical species in the cathode. Moreover, in this technology, especially in the case of a use over a long period of time, there has been a room for further improvement: since it is extremely difficult to completely prevent metal ions from entering the membrane electrode assembly, there is a possibility in which a decomposition reaction may be advanced gradually in the portions other than the vicinities of the cathode, for example, in the vicinities of an anode in the polymer electrolyte membrane.

Moreover, in the technology disclosed in the aforementioned Patent Document 2, especially in the case of a use over a long period of time, there also has been a room for improvement because since it is impossible to prevent metal ions from entering a membrane electrode assembly completely, causing a possibility in which entering of even a small amount of metal ions may cause generation of peroxides and radical species, and thus advance a decomposition reaction of the polymer electrolyte membrane.

In other words, even using the aforementioned technologies disclosed in Patent Document 1 and Patent Document 2, it is impossible to sufficiently suppress generation of radical species using the metal ion as a catalyst and decomposition and degradation of the polymer electrolyte membrane caused by the generated radical species. There has been therefore a room for improvement in these technologies in view of obtaining a satisfactory cell performance over a long period of time and further in view of sufficiently suppressing reduction in cell performance during operation and storage in the case of a use over a long period of time.

The present invention has been achieved in view of the aforementioned problems with an objective to provide a polymer electrolyte fuel cell excellent in durability that can suppress decomposition and degradation of a polymer electrolyte membrane over a long period of time notwithstanding repeated start and stop of the operation of the polymer electrolyte fuel cell. Another objective of the present invention is to provide a fuel cell system excellent in durability that can sufficiently prevent reduction in initial properties and can exert a satisfactory cell performance over a long period of time, by using the above-mentioned polymer electrolyte fuel cell of the present invention.

### Means for Solving the Problem

The inventors of the present invention have conducted diligent studies in order to achieve the above objectives and have found that although it has been conventionally considered that metal ions need be reduced as much as possible since they decompose and degrade a polymer electrolyte membrane, there can be provided a polymer electrolyte fuel cell excellent in durability that can suppress decomposition and degradation of a polymer electrolyte membrane over a long period of time and can sufficiently prevent reduction in initial properties by causing metal ions positively to be contained in the inside of a membrane electrode assembly of a polymer electrolyte fuel cell, and arrived at the present invention. The inventors of the present invention have further found that in order to achieve the above-mentioned objectives, it is highly effective to increase the amount of metal ions to be contained in a membrane electrode assembly contrary to the conventional idea, and to supplement a predetermined amount of metal ions to the membrane electrode assembly during the operation and the storage of a polymer electrolyte fuel cell over a long period of time, and arrived at the present invention.

Accordingly, in order to solve the above-mentioned problem, the present invention provides a fuel cell system including a polymer electrolyte fuel cell comprising: a membrane electrode assembly including a polymer electrolyte membrane with hydrogen ion conductivity, and a fuel electrode and an oxidant electrode sandwiching the polymer electrolyte membrane therebetween; a first separator plate for supplying and discharging a fuel gas to and from the fuel electrode; and a second separator plate for supplying and discharging an oxidant gas to and from the fuel electrode, characterized in that the system comprises a metal ion supplying means for supplying metal ions, which are stable in an aqueous solution, to the membrane electrode assembly such that the membrane electrode assembly contains the metal ions in an amount equivalent to 1.0 to 40.0% of the ion exchange group capacity of the polymer electrolyte membrane.

As mentioned above, by allowing a membrane electrode assembly of a polymer electrolyte fuel cell to contain metal ions, which are stable in an aqueous solution, such that the membrane electrode assembly contains the metal ions in an amount equivalent to 1.0 to 40% of the ion exchange group capacity of the polymer electrolyte membrane that constitutes the membrane electrode assembly, it is possible to obtain a polymer electrolyte fuel cell excellent in durability that can easily and surely suppress decomposition and degradation of the polymer electrolyte membrane over a long period of time notwithstanding repeated start and stop of the operation and can sufficiently prevent reduction in initial properties. Moreover, by using the polymer electrolyte fuel cell, it is possible to obtain a fuel cell system excellent in durability that can sufficiently prevent reduction in initial properties over a long period of time notwithstanding repeated start and stop of the operation.

Herein, the state “such that the membrane electrode assembly contains the metal ions in an amount equivalent to 1.0 to 40.0% of the ion exchange group capacity of the polymer electrolyte membrane” in the present invention refers to a state in which, assuming that the all metal ions contained in the membrane electrode assembly are completely ion-exchanged with the ion exchange group contained in the polymer electrolyte membrane and immobilized in the polymer electrolyte membrane, the total amount of the immobilized metal ions is equivalent to 1.0 to 40% of the ion exchange group capacity of the polymer electrolyte membrane.

When the amount of metal ions contained in the membrane electrode assembly, which are stable in an aqueous solution, is equivalent to less than 1.0% of the ion exchange group capacity of the polymer electrolyte membrane, decomposition and degradation of the polymer electrolyte membrane cannot be suppressed sufficiently and reduction in initial properties of the polymer electrolyte fuel cell cannot be prevented sufficiently, and as a result a fuel cell system comprising a polymer electrolyte fuel cell excellent in durability cannot be obtained. Further, in the case of more than 40.0%, since excessive metal ions trap the ion exchange group contained in the polymer electrolyte membrane and impair the continuity of the ion exchange group that contributes to proton conduction, causing degradation of the polymer electrolyte membrane and making it impossible to prevent reduction in initial properties of the polymer electrolyte fuel cell sufficiently. As a result, a fuel cell system including a polymer electrolyte fuel cell excellent in durability cannot be obtained.

In the fuel cell system of the present invention, it is preferable that the metal ion supplying means supplies the metal ions to the membrane electrode assembly such that the membrane electrode assembly contains the metal ions in an amount equivalent to 10.0 to 40.0% of the ion exchange group capacity of the polymer electrolyte membrane. This is preferable because peroxide such as H₂O₂ can be more surely decomposed in the case of not less than 10.0%.

Further, in the fuel cell system of the present invention, it is preferable that the metal ion supplying means supplies the metal ions to the membrane electrode assembly such that the membrane electrode assembly contains the metal ions in an amount equivalent to 10.0 to 20.0% of the ion exchange group capacity of the polymer electrolyte membrane. For example, as a result of the examination by the inventors of the present invention, it has been confirmed that in the case of 20.0% to 40.0%, compared with the case of 10.0 to 20.0%, reduction in the output voltage of the polymer electrolyte fuel cell to be incorporated in the fuel cell system of the present invention is approximately 10 mV and the reduction of power generation efficiency is approximately 1%. Consequently, in the case of 10.0 to 20.0%, compared with the case of 20.0 to 40.0%, higher output voltage and more excellent power generation efficiency can be obtained while degradation of the polymer electrolyte membrane can be suppressed sufficiently.

Herein, the ion exchange group capacity of a polymer electrolyte membrane refers to a value defined by an equivalent number of an ion exchange group contained in a polymer electrolyte (ion exchange resin) constituting the polymer electrolyte membrane per 1 g of dry resin, i.e., [milliequivalent/g dry resin](hereinafter referred to as meq/g).

In addition, the “dry resin” as used herein refers to a resin obtained by leaving a polymer electrolyte (ion exchange resin) in a dry nitrogen gas atmosphere (dew point −30° C.) for 24 hours or longer with the temperature kept at 25° C., in which reduction of mass by drying is hardly observed and the change in mass with passage of time is converged to a specific value.

Furthermore, the “metal ions” in the present invention refers to ions that are stable in an aqueous solution because of its easiness of handling and can be present in the polymer electrolyte membrane in a state in which they are exchanged with hydrogen ions, and are capable of suppressing decomposition and degradation of the polymer electrolyte membrane by being provided with at least one of a catalyst function for decomposing hydrogen peroxide generated in the electrode and a function for reducing the size of the hydrophilic cluster of the polymer electrolyte membrane.

Moreover, the amount of metal ions contained in the membrane electrode assembly of the present invention is determined by obtaining the membrane electrode assembly, then cutting it in a predetermined size to give a test piece, subsequently immersing the test piece in a 0.1 N solution of sulfuric acid at 90° C. for 3 hours, and quantifying the metal ions contained in the obtained solution by ICP spectroscopic analysis. Herein the metal ions are sometimes present as an ionic bonding compound at the time of analysis. In the case where the metal ions are present as an ionic bonding compound at the time of analysis (in the case where there is such possibility), an analysis sample is pretreated using acid and the like to be analyzed as metal ions.

### EFFECT OF THE INVENTION

According to the present invention, it is possible to obtain a polymer electrolyte fuel cell excellent in durability that can suppress decomposition and degradation of a polymer electrolyte membrane and can sufficiently prevent reduction in initial properties notwithstanding repeated start and stop of the operation, and further to obtain a fuel cell system excellent in durability that can sufficiently prevent reduction in initial properties notwithstanding repeated start and stop of the operation and exert a satisfactory cell performance over a long period of time by using the aforementioned polymer electrolyte fuel cell.

### BRIEF DESCRIPTION OF THE DRAWINGS

FIG. 1 A schematic sectional view illustrating an example of a basic configuration of a unit cell 1 to be incorporated in a polymer electrolyte fuel cell to be incorporated in a preferred embodiment of a fuel cell system of the present invention.

FIG. 2 A schematic sectional view illustrating an example of a basic configuration of a membrane electrode assembly 10 to be incorporated in the unit cell 1 as illustrated in FIG. 1.

FIG. 3 A schematic sectional view illustrating an example of a basic configuration of a preferred embodiment of the fuel cell system of the present invention.

FIG. 4 A graph showing changes in the electrical conductivity of drain water with passage of time in Evaluation Test 3 of Example 2 of the present invention.

FIG. 5 A graph showing changes in the amount of fluoride ions eluted into drain water with passage of time during a continuous operation of a polymer electrolyte fuel cell in Evaluation Test 4 of Example 3 of the present invention.

FIG. 6 A graph showing changes in the amount of fluoride ions eluted into drain water with passage of time during a continuous operation of a polymer electrolyte fuel cell in Evaluation Test 4 of Comparative Example 6 of the present invention.

FIG. 7 A schematic sectional view illustrating an example of a basic configuration of a unit cell 100 to be incorporated in a preferred embodiment of the conventional polymer electrolyte fuel cell.

FIG. 8 A schematic sectional view illustrating an example of a basic configuration of a membrane electrode assembly 101 to be incorporated in the unit cell 100 as illustrated in FIG. 7.

### BEST MODE FOR CARRYING OUT THE INVENTION

A preferred embodiment of the present invention will be hereinafter described in detail with reference to the drawings. An identical or similar part is denoted by a same numeral and the explanation thereof may be omitted.

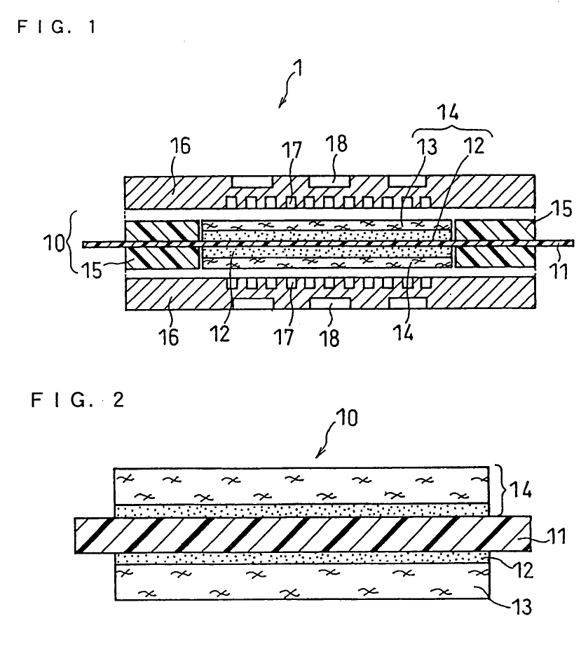

FIG. 1 is a schematic sectional view illustrating an example of a basic configuration of a unit cell to be incorporated in a polymer electrolyte fuel cell to be incorporated in a preferred embodiment of a fuel cell system of the present invention. And FIG. 2 is a schematic sectional view illustrating an example of a basic configuration of a membrane electrode assembly to be incorporated in the unit cell 1 as illustrated in FIG. 1.

A polymer electrolyte fuel cell (not illustrated) of this embodiment has a configuration in which a plurality of unit cells 1 as illustrated in FIG. 1 are stacked.

As illustrated in FIG. 1, the unit cell 1 is mainly constituted of a membrane electrode assembly 10, gaskets 15, and a pair of separator plates 16 as mentioned below. The gaskets 15 are arranged on the peripheries of the electrodes in a state in which the outwardly extended portion of a polymer electrolyte membrane 11 is sandwiched thereby in order to prevent a fuel gas supplied to the membrane electrode assembly 10 from leaking to the outside, prevent an oxidant gas from leaking to the outside, and prevent the fuel gas and the oxidant gas from being mixed together.

As illustrated in FIG. 2, the membrane electrode assembly 10 is configured such that a catalyst layer 12 is formed on both sides of the polymer electrolyte membrane 11 that selectively transports hydrogen ions, the catalyst layer comprising a catalyst body obtained by allowing an electrode catalyst (for example, a platinum-based metal catalyst) to be carried on carbon powder and a polymer electrolyte with cation (hydrogen ion) conductivity.

As the polymer electrolyte membrane 11, a polymer electrolyte membrane comprising perfluorocarbon sulfonic acid (for example, Nafion (trade name) available from E. I. du Pont de Nemours and Company) may be used. On the outside surface of the catalyst layer 12, a gas diffusion layer 13 having gas permeability and electron conductivity is formed using, for example, carbon paper with water-repellent treatment applied thereon. A gas diffusion electrode (a fuel electrode or an oxidant electrode) 14 is formed of a combination of the catalyst layer 12 and the gas diffusion layer 13.

On the outside surface of the membrane electrode assembly 10, a pair of separator plates 16 for mechanically fixing the membrane electrode assembly 10 are arranged. On the face of the separator plate 16 in contact with the membrane electrode assembly 10, there is formed a gas flow channel 17 for supplying a fuel gas or an oxidant gas (a reactant gas) to the electrode and carrying away gas containing electrode reaction products or non-reacted reactants to the outside of the unit cell 1.

As mentioned above, by fixing the membrane electrode assembly 10 with the pair of the separator plates 16 and supplying the fuel gas to the gas flow channel 17 on one of the separator plates 16 and supplying the oxidant gas to the gas flow channel 17 on the other one of the separator plates 16, electromotive force of a certain level can be generated from one unit cell 1. However, in general, using a polymer electrolyte fuel cell as a power source usually requires a voltage of several volts to several hundreds volts. Therefore, in actual use, a configuration of stack in which a necessary number of the unit cells 1 are connected in series is employed as in the embodiment of the present invention.

In order to supply the reactant gas to the gas flow channel 17, it is necessary to use a manifold, which is a member for dividing a reactant gas supply pipe into branches corresponding to the number of separators to use, and connecting one end of the branch directly with the gas flow channel on the separator plate. A type of manifold for connecting an external pipe for supplying the reactant gas directly to the separator plate is particularly called an external manifold. There is another type of manifold with a simplified structure, which is called an internal manifold. The internal manifold is composed of through holes provided on the separator plate with a gas flow channel formed thereon. The inlet/outlet of the gas flow channel is in communication with the through hole so that the reactant gas can be directly supplied to the gas flow cannel via the through hole. In the present invention, either one of these types of manifold may be employed.

As a material of the separator plate 16, various kinds of materials such as a material made of metal or carbon, and a material obtained by mixing graphite and resin can be used.

Moreover, a material constituting a gas diffusion layer is not necessarily limited, and any material known in the art may be used. For example, carbon paper, carbon cloth and the like may be used.

Next, the aforementioned catalyst layer 12 is formed of conductive carbon particles with an electrode catalyst comprising a noble metal carried thereon and a polymer electrolyte having cation (hydrogen ion) conductivity. In formation of the catalyst layer 12, an ink for forming a catalyst layer containing at least conductive carbon particles with an electrode catalyst comprising a noble metal carried thereon, a polymer electrolyte having cation (hydrogen ion) conductivity, and a dispersion medium is used.

The polymer electrolyte is preferably exemplified by an electrolyte having a sulfonic acid group, a carboxylic acid group, a phosphonic acid group, a sulfonimide group, or the like as a cation exchange group. In view of hydrogen ion conductivity, an electrolyte having a sulfonic group is particularly preferable.

As the polymer electrolyte having a sulfonic acid group, a polymer electrolyte having an ion exchange capacity ranging from 0.5 to 1.5 meq/g dry resin is preferable. This is preferable because when the polymer electrolyte has an ion exchange capacity of not less than 0.5 meq/g dry resin, the resistance of the catalyst layer during power generation can be sufficiently reduced; and when the ion exchange capacity is not more than 1.5 meq/g dry resin, moisture content in the catalyst layer can be easily maintained at an appropriate level, moderate wetness can be ensured, and flooding due to clogging of the micropores can be surely prevented. It is particularly preferable that the ion exchange capacity is in the range from 0.8 to 1.2 meq/g dry resin.

Preferable as the polymer electrolyte is a copolymer of containing a polymerization unit based on a perfluorovinyl compound expressed by CF₂═CF—(OCF₂CFX)ₘ—Oₚ—(CF₂)ₙ—SO₃H (where m represents an integer from 0 to 3, n represents an integer from 1 to 12, p represents 0 or 1, and X represents a fluorine atom or a trifluoromethyl group) and a polymerization unit based on tetrafluoroethylene.

The aforementioned fluorovinyl compound is preferably exemplified by the following compounds expressed by the formulae (2) to (4). In the formulae, q represents an integer from 0 to 8, r represents an integer from 1 to 8, and t represents an integer from 1 to 3.

CF₂═CFO(CF₂)_{q}—SO₃H (2)

CF₂═CFOCF₂CF(CF₃)O(CF₂)ᵣ—SO₃H (3)

CF₂═CF(OCF₂CF(CF₃))ₜO(CF₂)₂—SO₃H (4)

The polymer electrolyte is specifically exemplified by “Nafion” (trade name) available from E. I. du Pont de Nemours and Company, “Flemion” (trade name) available from Asahi Glass Co. Ltd., and the like. The aforementioned polymer electrolytes may be used as a composite material of the polymer electrolyte membrane.

The electrode catalyst used in the present invention is used in a state in which it is carried on the conductive carbon particles (powder), and is composed of metal particles. The metal particles are not necessarily limited and particles of various metals may be used. For example, it is preferable to use one or more metals selected from the group consisting of platinum, gold, silver, ruthenium, rhodium, palladium, osmium, iridium, chromium, iron, titanium, manganese, cobalt, nickel, molybdenum, tungsten, aluminum, silicon, zinc and tin. Among these, noble metal, platinum, and an alloy with platinum are preferable. In particular, an alloy of platinum and ruthenium is preferable since the activity of the catalyst is stable in the anode.

It is preferable that the conductive carbon particle has a specific surface area of 50 to 1500 m²/g. This is preferable because when the specific surface area is not less than 50 m²/g, the carrying ratio of the electrode catalyst can be easily increased, and thus favorable output properties of the catalyst layer can be more surely obtained; and when the specific surface area is not more than 1500 m²/g, appropriate micropores can be secured, the coating with the polymer electrolyte can be facilitated, and thus favorable output properties of the catalyst layer can be more surely obtained. It is particularly preferable that the specific surface area is 200 to 900 m²/g.

Further, it is preferable that the particles of the electrode catalyst has a mean particle size of 1 to 5 nm. This is preferable because when the mean particle size is not less than 1 nm, the electrode catalyst can be more easily prepared industrially; and when the mean particle size is not more than 5 nm, more sufficient activity per electrode catalyst mass can be easily obtained, and thus this can make contribution to cost reduction of the fuel cell.

Moreover, it is preferable that the conductive carbon particles have a mean particle size of 0.1 to 1.0 μm. This is preferable because when the mean particle size is not less than 0.1 μm, a favorable gas diffusion property of the catalyst layer can be more easily obtained, and thus flooding can be more surely prevented; and when the mean particle size is not more than 1.0 μm, coating of the electrode catalyst with the polymer electrolyte can be facilitated, a coating area can be secured, and thus a satisfactory performance of the catalyst layer can be more easily obtained.

In the present invention, as the dispersion medium used for preparing the ink for forming a catalyst layer, it is preferable to use a liquid containing alcohol capable of dissolving or dispersing the polymer electrolyte (including a dispersion state in which the polymer electrolyte is partly dissolved).

It is preferable that the dispersion medium contains at least one of water, methanol, propanol, n-butyl alcohol, isobutyl alcohol, sec-butyl alcohol and tert-butyl alcohol. These water and alcohols may be used singly or in combination of two or more. As the alcohol, straight-chain alcohol having one OH group in the molecular is particularly preferable, and ethanol is particularly preferable. Such alcohol includes alcohol that has an ether bond such as ethylene glycol and monomethyl ether.

Further, it is preferable that the ink for forming a catalyst layer has a solid concentration of 0.1 to 20 mass %. When the solid concentration is not less than 0.1 mass %, in formation of a catalyst layer by spraying or coating the ink for forming a catalyst layer, a catalyst layer having a predetermined thickness can be obtained without spraying or coating it repeatedly many times, and thus sufficient production efficiency can more easily obtained. And when the solid concentration is not more than 20 mass %, a mixture solution having an appropriate viscosity can be easily obtained, and thus a favorable and uniform dispersion state of the component materials in the catalyst layer can be easily obtained. It is particularly preferable that the solid concentration is from 1 to 10 mass %.

Furthermore, in the present invention, it is preferable to prepare the ink for forming a catalyst layer such that the mass ratio between the electrode catalyst and the polymer electrolyte in solid form is 50:50 to 85:15. This is preferable because this enables the polymer electrolyte to coat the electrode catalyst efficiently, and thus in fabrication of a membrane electrode assembly, the three-phase zone can be increased. Further, in the aforementioned mass ratio, when the amount of electrode catalyst is of not less than 50:50, sufficient micropores can be secured in a conductive carbon particle as a carrier, a sufficient reaction site can be secured, and thus sufficient performance as a polymer electrolyte fuel cell can be more easily secured. Further, in the aforementioned mass ratio, when the amount of electrode catalyst is of not more than 85:15, sufficient coating of the electrode catalyst with the polymer electrolyte can be more easily obtained, and thus sufficient performance as a polymer electrolyte fuel cell can be more easily obtained. It is particularly preferable to carry out the preparation in such a manner that the mass ratio between the electrode catalyst and the polymer electrolyte is 60:40 to 80:20.

In the present invention, the ink for forming a catalyst layer may be prepared according to the well-known method. The method specifically is exemplified by a method of utilizing high speed rotation, for example, a method of using a mixer such as a homogenizer and a homomixer and a method of using a high speed jet stream system; and a method of applying shearing stress to a dispersion by applying high pressure using a high pressure emulsification apparatus and the like to eject the dispersion from a narrow portion.

In formation of a catalyst layer using the ink for forming a catalyst layer of the present invention, a catalyst layer is formed on a support sheet. For example, the ink for forming a catalyst layer is sprayed or applied onto the support sheet to coat the support sheet, and then a liquid membrane composed of the ink for forming a catalyst layer is dried to form a catalyst layer on the support sheet.

Herein, in the present invention, the gas diffusion electrode may be (I) composed of the catalyst layer singly or (II) composed of the gas diffusion layer with the catalyst layer formed thereon, that is, a combination of the gas diffusion layer and the catalyst layer.

In the case of (I), the catalyst layer obtained by peeling it from the support sheet may be produced as a product (a gas diffusion electrode), or the catalyst layer formed peelably on the support sheet may be produced as a product. The support sheet is exemplified by, as hereinafter described, a sheet made of synthetic resin not dissolvable in a mixture solution for forming a catalyst layer, a laminate film having a structure in which a layer made of synthetic resin and a layer made of metal are laminated, a metallic sheet, a sheet made of ceramics, a sheet made of an inorganic/organic composite material, and a polymer electrolyte membrane.

In addition, in the case of (II), one or more other layers such as a water repellent layer may be disposed between the gas diffusion layer and the catalyst layer. Moreover, an electrode with the aforementioned support sheet peelably bonded on the catalyst layer on the face opposite to the gas diffusion layer may be produced as a product.

Usable as the support sheet is one selected from (i) a polymer electrolyte membrane, (ii) a gas diffusion layer made of a microporous material having a gas diffusion property and an electron conductivity, and (iii) a sheet made of synthetic resin not dissolvable in the mixture solution, a laminate film having a structure in which a layer made of synthetic resin and a layer made of metal are laminated, a metallic sheet, a sheet made of ceramics, a sheet made of an inorganic/organic composite material may be used.

The aforementioned synthetic resin is exemplified by polypropylene, polyethylene terephthalate, ethylene/tetrafluoroethylene copolymer, polytetrafluoroethylene, and the like.

Usable as a method for applying a mixture solution in formation of the catalyst layer 12 are a method of using an applicator, a bar coater, a die coater, a spray, etc., a screen printing method, a gravure printing method, and the like.

It is preferable that the two catalyst layers 12 of the membrane electrode assembly 10 independently has a thickness of 3 to 50 μm. This is preferable because when the thickness is not less than 3 μm, a uniform catalyst layer is easily formed, a sufficient amount of catalyst is easily secured, and thus sufficient durability can be secured; and when the thickness is not more than 30 μm, gas supplied to the catalyst layer 12 is easily diffused, and the reaction is easily proceeded to the full. In view of achieving the effects of the present invention more surely, it is particularly preferable that the two catalyst layers 12 of the membrane electrode assembly 10 independently has a thickness of 5 to 30 μm.

The gas diffusion layer 14, the membrane electrode assembly 10 and the polymer electrolyte fuel cell are produced using the catalyst layer 12 obtained as mentioned above.

In doing so, in the case where the polymer electrolyte membrane of the aforementioned (i) is used as the support sheet, it is possible to form a catalyst layer on both faces the polymer electrolyte membrane, subsequently sandwich the whole with gas diffusion layers formed of a material such as carbon paper, carbon cross, or carbon felt, and then to bond the layers using the known technology such as hot pressing.

Further, in the case where the gas diffusion layer of the aforementioned (ii) is used as the support sheet, it is possible to sandwich the polymer electrolyte membrane with two gas diffusion layers each having a catalyst layer in a manner such that the catalyst layer faces the polymer electrolyte membrane, and then bond them using the known technology such as hot pressing.

Further, in the case where a catalyst layer is formed on the support sheet of the aforementioned (iii), it is possible to make the support sheet with a catalyst layer to be in contact with at least one of the polymer electrolyte membrane and the gas diffusion layer, subsequently peel the support sheet to transfer the catalyst layer, and bond them using the known technology.

In the present invention, metal ions are allowed to be carried on a membrane electrode assembly comprising a gas diffusion electrode including a catalyst layer and a gas diffusion layer, and a polymer electrolyte membrane.

One possible method for doing this is to impregnate the polymer electrolyte membrane with an aqueous solution containing metal ions before attaching the catalyst layer and the gas diffusion layer thereto, then dry the membrane to allow the metal ions, which are stable in an aqueous solution, to be carried thereon, and subsequently bond the catalyst layer and the gas diffusion layer on the polymer electrolyte membrane carrying the metal ions.

Another possible method is to impregnate the polymer electrolyte membrane having the catalyst layer with an aqueous solution containing metal ions, then dry the membrane to allow the metal ions, which are stable in an aqueous solution, to be carried thereon, and subsequently bond the gas diffusion layer thereon.

Still another possible method is to bond the catalyst layer and the gas diffusion layer onto the polymer electrolyte membrane to give a membrane electrode assembly, to impregnate the assembly with an aqueous solution containing metal ions and then dry the assembly to cause the metal ions, which are stable in an aqueous solution, to be carried thereon.

As mentioned above, the metal ions used in the present invention are stable in an aqueous solution because of its easiness of handling, present in the polymer electrolyte membrane in a state in which they have been exchanged with hydrogen ions, and are capable of suppressing decomposition and degradation of the polymer electrolyte membrane by being provided with at least either a catalyst function for decomposing hydrogen peroxide generated in the electrode or a function for reducing the size of the hydrophilic cluster of the polymer electrolyte membrane.

As a specific example of the aforementioned metal ions, in view of capable of suppressing decomposition and degradation of the polymer electrolyte membrane by decomposing hydrogen peroxide generated in the electrode, at least one selected from the group consisting of iron ions, copper ions, chromium ions, nickel ions, molybdenum ions, titanium ions and manganese ions is preferable.

Among these, at least one selected from the group consisting of iron ions, copper ions, nickel ions, molybdenum ions, titanium ions and manganese ions is preferable.

Further, the iron ions preferably include Fe²⁺ in view of their extremely high stability in an aqueous solution and necessity of securing their stability in the aqueous solution in the anode side more sufficiently.

Alternatively, as the aforementioned metal ions, in view of improving decomposition resistance of the polymer electrolyte membrane by reducing the size of the hydrophilic cluster of the polymer electrolyte membrane, at least one selected from the group consisting of sodium ions, potassium ions, calcium ions, magnesium ions and aluminum ions is preferable.

The aqueous solution containing metal ions can be prepared by dissolving metal salt and the like in water. One skilled in the art would appropriately adjust the metal ion concentration of the aqueous solution containing metal ions according to the amount of metal ions to be carried on the membrane electrode assembly.

Next, the membrane electrode assembly 10 obtained as mentioned above contains the aforementioned metal ions immediately after it is fabricated; however, during repeated start and stop of the operation of the polymer electrolyte fuel cell comprising the membrane electrode assembly, the metal ions are gradually eluted into drain water and discharged from the polymer electrolyte fuel cell to the outside with the drain water. When the metal ions have been exhausted, the amount of metal ions contained in the membrane electrode assembly 10 is reduced, and thus there may cause a gradual reduction in the effects of the present invention of suppressing decomposition and degradation of the polymer electrolyte membrane 11.

Accordingly, in the fuel cell system of the present invention, the membrane electrode assembly 10 is preferably provided with a metal ion supply means for supplying metal ions, which are stable in an aqueous solution, to the membrane electrolyte assembly 10. With such a configuration, it is possible to maintain the metal ion concentration in the membrane electrode assembly of the polymer electrolyte fuel cell during operation or during storage at a specific level, suppress decomposition and degradation of the polymer electrolyte membrane over a long period of time, suppress reduction in initial properties of the polymer electrolyte fuel cell, and thus provide an excellent durability.

Although, the metal ion supplying means is not necessarily limited as long as the means has a configuration in which the metal ions, which are stable in an aqueous solution, can be supplied to the membrane electrode assembly without impairing the effects of the present invention, the means is mainly exemplified by a first type means of supplying the metal ions, which are stable in an aqueous solution, as an aqueous solution; and a second type means of employing a metal ion generating member for generating metal ions, which are stable in an aqueous solution, by a chemical reaction.

The first type metal ion supplying means may be disposed in the inside of the polymer electrolyte fuel cell, or alternatively may be disposed in the outside of the polymer electrolyte fuel cell as mentioned below. In either case, the fuel cell system of the present invention is constituted of the aforementioned metal ion supplying means and the polymer electrolyte fuel cell.

Herein, the metal ion supplying means may be constituted of, for example, a metal ion tank including an aqueous solution containing metal ions and a solenoid valve. Alternatively, it is possible to spray a solution containing metal ions to the inside of the stack of the polymer electrolyte fuel cells.

In the second type metal ion supplying means, a metal ion generating member is arranged in the inside or in a vicinity of the membrane electrode assembly, the metal ion generating member being formed of a metal, a metal compound or an alloy, from which metal ions, which are stable in an aqueous solution, are generated electrochemically or chemically, specifically, by oxidizing or decomposing the member chemically. Therefore, the second type metal ion supplying means is mainly disposed in the inside of the polymer electrolyte fuel cell.

For example, a metal plate and the like, from which the aforementioned metal ions are generated as a cell reaction proceeds, may be used as the metal ion generating member. Accordingly, as a material for a separator plate in a unit cell, there may be used are a metal, a metal compound or an alloy, from which the aforementioned metal ions are generated as a cell reaction proceeds.

Next, a preferred embodiment of the fuel cell system according to the present invention is described. FIG. 3 is a system diagram illustrating an example of a basic configuration of a preferred embodiment of the fuel cell system of the present invention.

As illustrated in FIG. 3, a fuel cell system 30 of this embodiment comprises a polymer electrolyte fuel cell 31 including unit cells C1, C2, and Cn (where n is a natural number), a metal ion tank 34a and a metal ion tank 34b that correspond to the aforementioned second type metal ion supplying means. Herein, the unit cell C1, C2, . . . and Cn has a configuration similar to that of the aforementioned unit cell 1 as illustrated in FIG. 1. Further, the fuel cell system 30 comprises a fuel gas controller 33 for supplying a fuel gas, an oxidant gas controller 32 for supplying an oxidant gas, and an output voltage monitor portion 36 for monitoring output voltage of the polymer electrolyte fuel cell 31. And the fuel gas controller 33, the oxidant gas controller 32, the polymer electrolyte fuel cell 31, and the output voltage monitor portion 36 are all controlled by a controller 35.

The metal ion tank 34a is disposed at some point of the piping connecting the fuel gas controller 33 to the polymer electrolyte fuel cell 31, and is provided with a control valve such as a solenoid valve capable of controlling the amount of metal ions to be supplied, the valve not being illustrated. The metal ion tank 34b is disposed at some point of the piping connecting the oxidant gas controller 32 to the polymer electrolyte fuel cell 31, and is provided with a control valve such as a solenoid valve capable of controlling the amount of metal ions to be supplied, the valve not being illustrated.

In the fuel cell system 30 of this embodiment, it is preferable that metal ions are supplied at least from the fuel electrode side of the membrane electrode assembly (not illustrated, see FIG. 2) using the metal ion supplying means (the metal ion tank 34a and the metal ion tank 34b). In other words, the metal ion tank 34a is preferably disposed at some point of the piping connecting the fuel gas controller 33 to the polymer electrolyte fuel cell 31. This is because since metal ions are cations like hydrogen ions and flow from the fuel electrode to the air electrode when the cell is in a power generating state, the metal ions are smoothly captured in the polymer electrolyte membrane when supplied to the fuel electrode; however, when supplied to the air electrode, the metal ions enter in the direction opposing to the flow of hydrogen ions; and as a result, the amount of metal ions uncaptured in the polymer electrolyte membrane and discharged to the outside is increased. Accordingly, in supplying metal ions, it is more efficient to supply the metal ions to the polymer electrolyte membrane from the fuel electrode side.

The rate of supplying an aqueous solution containing metal ions using the metal ion supplying means (the metal ion tank 34a and the metal ion tank 34b) may be adjusted at an appropriate level, as long as the amount of metal ions having eluted from the membrane electrode assembly during power generation of the polymer electrolyte fuel cell by activation of the fuel cell system 30 can be supplemented. Herein, the rate of supplying an aqueous solution containing metal ions can be adjusted according to the various operational requirements of the polymer electrolyte fuel cell 31.

Moreover, the fuel cell system 30 preferably comprises a means for collecting metal ions from drain water. In this means, a sulfate solution containing metal ions can be obtained by, for example, trapping the metal ions eluted into the drain water with an ion exchange resin and recovering it with a sulfuric acid solution appropriately.

A recycling-based fuel cell system with respect to metal ions can be achieved by collecting the metal ions contained in the drain water, which have been eluted during power generation of the polymer electrolyte fuel cell 31, and then supplying the collected metal ions back to the metal ion supplying means such as the metal ion tanks 34a and 34b, to recycle them. According to the recycling-based fuel cell system, a long time operation without a necessity of supplementing an aqueous solution containing metal ions is more surely realized.

Furthermore, in the controller 35, it is preferable to confirm the degree of decomposition and degradation of the polymer electrolyte membrane and the amount (concentration) of the metal ions eluted by monitoring the conductivity (or concentration of fluoride ions) of the drain water from the polymer electrolyte fuel cell 31. Moreover, it is preferable to prepare a table that shows a relation between the conductivity of the drain water and the concentration of the metal ions, and further shows a relation between these and the amount of metal ions contained in the membrane electrode assembly in advance according to the temperature requirements, the operational requirements, the current density, and the like of the polymer electrolyte fuel cell 31, and to make the controller 35 to memorize the data in the table as a database in advance and to control the fuel cell system 30 in accordance with the database.

If the amount of metal ions contained in the membrane electrode assembly can be monitored as mentioned above, it is possible to judge the timing at which metal ions are to be supplied using the metal ion supplying means and the amount of metal ions to be supplied.

In addition to that, as a criterion of the concentration of the metal ions in the membrane electrode assembly, there may be used changes in impedance of the membrane electrode assembly or the polymer electrolyte fuel cell since the resistance of the polymer electrolyte membrane varies according to the concentration of the metal ions.

Although the embodiments of the present invention have been described in detail, it is to be understood that the present invention is not necessarily limited to the aforementioned embodiments.

For example, although in the polymer electrolyte fuel cell to be incorporated in the aforementioned preferred embodiment of the fuel cell system according to the present invention, the embodiment in which a plurality of unit cells 1 are stacked is described, the fuel cell system of the present invention is not necessarily limited thereto. For example, the polymer electrolyte fuel cell to be incorporated in the fuel cell system according to the present invention may be formed of one unit cell 1.

### EXAMPLE

Although the present invention will be hereinafter described referring to Examples and Comparative Examples, it is to be noted that the present invention is not limited to these Examples.

### Example 1

First, a polymer electrolyte fuel cell of the present invention was fabricated.

In order to allow a membrane electrode assembly to carry Fe ions, Fe ions were allowed to be carried on a polymer electrolyte membrane that is a component thereof. On the polymer electrolyte membrane (Nafion 112 membrane of E. I. du Pont de Nemours and Company, ion exchange group capacity: 0.9 meq/g), the portion excepting the portion to be coated with a catalyst layer was masked with a film made of polyetherimide. Then the masked polymer electrolyte membrane was immersed in an aqueous solution containing Fe ions at a predetermined concentration for 12 hours, and then washed with water and dried, whereby the Fe ions were carried on the membrane. Herein, as the aqueous solution containing Fe ions, a 0.001 M aqueous solution of ferrous sulfate (II) was used.

Herein, the amount of Fe ions in the membrane electrode assembly was determined by cutting the obtained membrane electrode assembly in a predetermined size to give a test piece, then immersing the test piece in the 0.1 N solution of sulfuric acid at 90° C. for 3 hours, and quantifying the Fe ions contained in the obtained solution by ICP spectroscopic analysis. As a result, the amount of Fe ions was equivalent to 1.0% of the ion exchange group capacity of the polymer electrolyte membrane.

Next, a gas diffusion layer was fabricated. Acetylene black (Denka black, available from Denki Kagaku Kogyo Kabushiki Kaisha, particle size 35 nm) was mixed with an aqueous dispersion of polytetrafluoroethylene (PTFE) (D1, available from Daikin Industries, Ltd.), whereby a water-repellent ink containing 20 mass % of PTFE (dry weight) was prepared.

The ink was then applied onto the surface of carbon cross (CARBOLON GF-20-31E, available from Nippon Carbon Co., Ltd.) and subsequently heated at 300° c. using a hot air dryer to form a gas diffusion layer (approximately 200 μm).

Next, a catalyst layer was fabricated. 66 parts by mass of catalyst body (containing 50 mass % of Pt) obtained by allowing platinum as an electrode catalyst to be carried on Ketjen black (Ketjen Black EC, available from Ketjen Black International Company, particle size 30 nm) as carbon powder was mixed with 33 parts by mass of perfluorocarbon sulfonic acid ionomer (5 mass % Nafion dispersion, available from Aldrich in the US) as a hydrogen ion conductive material and a binder, and then the resultant mixture was formed into a catalyst layer (10 to 20 μm).

The gas diffusion layer and the catalyst layer obtained as mentioned above were bonded on both sides of the polymer electrolyte membrane carrying Fe ions and the whole was integrated by hot pressing, whereby a membrane electrode assembly as illustrated in FIG. 2 was fabricated.

Subsequently, a rubber gasket plate was bonded on the periphery of the polymer electrolyte membrane of the membrane electrode assembly fabricated as mentioned above, and manifold apertures for passage of a fuel gas and an oxidant gas therethrough were formed. A separator plate made of phenol resin-impregnated graphite plate having an external size of 10 cm×10 cm×1.3 mm and provided with a gas flow channel having a width of 0.9 mm and a depth of 0.7 mm, was prepared.

As illustrated in FIG. 1, the separator plate is provided with a groove on the side facing to the membrane electrode assembly 10 by drilling to give a gas flow channel 17, and provided with a groove on the opposite side to give a cooling water flow channel 18. The two separator plates 16 were used. On one face of the membrane electrode assembly 10, the separator plate 16 with a gas flow channel for oxidant gas formed thereon is laminated; and on the other face, the separator plate 16 with a flow channel for fuel gas formed thereon was laminated, whereby a unit cell 1 was obtained.

Current collector plates made of stainless steel, and insulating plates made of an electrically-insulating material and end plates were arranged on both ends of the unit cell, and further, with the use of clamping rods, the whole was fixed. The clamping pressure with respect to the area of the separator was 10 kgf/cm².

A polymer electrolyte fuel cell of the present invention comprising of one unit cell was obtained as mentioned above.

### Examples 2 to 4

Membrane electrode assemblies according to the present invention and polymer electrolyte fuel cells of the present invention having the same configuration as that of Example 1 were fabricated, except that the amount of Fe ions carried on the polymer electrolyte membrane of the membrane electrode assembly was changed to the amount as shown in below-mentioned Table 1.

### Comparative Examples 1 to 7

Membrane electrode assemblies and a polymer electrolyte fuel cell having the same configuration as that of Example 1 were fabricated, except that the amount of Fe ions carried on the polymer electrolyte membrane of the membrane electrode assembly was changed to the amount as shown in below-mentioned Table 1.

### Examples 5 to 8

Membrane electrode assemblies according to the present invention and polymer electrolyte fuel cells of the present invention having the same configuration as that of Example 1 were fabricated, except that an aqueous solution containing Cu ions was used in place of the aqueous solution containing Fe ions, and the polymer electrolyte membrane of the membrane electrode assembly was caused to carry Cu ions in an amount as shown in the below-mentioned Table 2.

### Comparative Examples 8 to 12

Membrane electrode assemblies and polymer electrolyte fuel cells having the same configuration as that of Example 1 were fabricated, except that the amount of Cu ions carried on the polymer electrolyte membrane of the membrane electrode assembly was changed to the amount as shown in the below-mentioned Table 2.

### Examples 9 to 12

Membrane electrode assemblies according to the present invention and polymer electrolyte fuel cells of the present invention having the same configuration as that of Example 1 were fabricated, except that an aqueous solution containing Mn ions was used in place of the aqueous solution containing Fe ions, and the polymer electrolyte membrane of the membrane electrode assembly was caused to carry Mn ions in an amount as shown in the below-mentioned Table 3.

### Comparative Examples 13 to 17

Membrane electrode assemblies and polymer electrolyte fuel cells having the same configuration as that of Example 1 were fabricated, except that the amount of Mn ions carried on the polymer electrolyte membrane of the membrane electrode assembly was changed to the amount as shown in the below-mentioned Table 3.

### Examples 13 to 16

Membrane electrode assemblies according to the present invention and polymer electrolyte fuel cells of the present invention having the same configuration as that of Example 1 were fabricated, except that an aqueous solution containing Cr ions was used in place of the aqueous solution containing Fe ions, and the polymer electrolyte membrane of the membrane electrode assembly was caused to carry Cr ions in an amount as shown in the below-mentioned Table 4.

### Comparative Examples 18 to 22

Membrane electrode assemblies and polymer electrolyte fuel cells having the same configuration as that of Example 1 were fabricated, except that the amount of Cr ions carried on the polymer electrolyte membrane of the membrane electrode assembly was changed to the amount as shown in the below-mentioned Table 4.

### Examples 17 to 20

Membrane electrode assemblies according to the present invention and polymer electrolyte fuel cells of the present invention having the same configuration as that of Example 1 were fabricated, except that an aqueous solution containing Ni ions was used in place of the aqueous solution containing Fe ions, and the polymer electrolyte membrane of the membrane electrode assembly was caused to carry Ni ions in an amount as shown in the below-mentioned Table 5.

### Comparative Examples 23 to 27

Membrane electrode assemblies and polymer electrolyte fuel cells having the same configuration as that of Example 1 were fabricated, except that the amount of Ni ions carried on the polymer electrolyte membrane of the membrane electrode assembly was changed to the amount as shown in the below-mentioned Table 5.

### Examples 21 to 24

Membrane electrode assemblies according to the present invention and polymer electrolyte fuel cells of the present invention having the same configuration as that of Example 1 were fabricated, except that an aqueous solution containing Mo ions was used in place of the aqueous solution containing Fe ions, and the polymer electrolyte membrane of the membrane electrode assembly was caused to carry Mo ions in an amount as shown in the below-mentioned Table 6.

### Comparative Examples 28 to 32

Membrane electrode assemblies and polymer electrolyte fuel cells having the same configuration as that of Example 1 were fabricated, except that the amount of Mo ions carried on the polymer electrolyte membrane of the membrane electrode assembly was changed to the amount as shown in the below-mentioned Table 6.

### Examples 25 to 28

Membrane electrode assemblies according to the present invention and polymer electrolyte fuel cells of the present invention having the same configuration as that of Example 1 were fabricated, except that an aqueous solution containing Ti ions was used in place of the aqueous solution containing Fe ions, and the polymer electrolyte membrane of the membrane electrode assembly was caused to carry Ti ions in an amount as shown in the below-mentioned Table 7.

### Comparative Examples 33 to 37

Membrane electrode assemblies and polymer electrolyte fuel cells having the same configuration as that of Example 1 were fabricated, except that the amount of Ti ions carried on the polymer electrolyte membrane of the membrane electrode assembly was changed to the amount as shown in the below-mentioned Table 7.

### Examples 29 to 31

Membrane electrode assemblies according to the present invention and polymer electrolyte fuel cells of the present invention having the same configuration as that of Example 1 were fabricated, except that an aqueous solution containing Na ions was used in place of the aqueous solution containing Fe ions, and the polymer electrolyte membrane of the membrane electrode assembly was caused to carry Na ions in an amount as shown in the below-mentioned Table 8.

### Comparative Examples 38 to 43

Membrane electrode assemblies and polymer electrolyte fuel cells having the same configuration as that of Example 1 were fabricated, except that the amount of Na ions carried on the polymer electrolyte membrane of the membrane electrode assembly was changed to the amount as shown in the below-mentioned Table 8.

### Examples 32 to 35

Membrane electrode assemblies according to the present invention and polymer electrolyte fuel cells of the present invention having the same configuration as that of Example 1 were fabricated, except that an aqueous solution containing K ions was used in place of the aqueous solution containing Fe ions, and the polymer electrolyte membrane of the membrane electrode assembly was caused to carry K ions in an amount as shown in the below-mentioned Table 9.

### Comparative Examples 44 to 48

Membrane electrode assemblies and polymer electrolyte fuel cells having the same configuration as that of Example 1 were fabricated, except that the amount of K ions carried on the polymer electrolyte membrane of the membrane electrode assembly was changed to the amount as shown in the below-mentioned Table 9.

### Examples 36 to 39

Membrane electrode assemblies according to the present invention and polymer electrolyte fuel cells of the present invention having the same configuration as that of Example 1 were fabricated, except that an aqueous solution containing Mg ions was used in place of the aqueous solution containing Fe ions, and the polymer electrolyte membrane of the membrane electrode assembly was caused to carry Mg ions in an amount as shown in the below-mentioned Table 10.

### Comparative Examples 49 to 53

Membrane electrode assemblies and polymer electrolyte fuel cells having the same configuration as that of Example 1 were fabricated, except that the amount of Mg ions carried on the polymer electrolyte membrane of the membrane electrode assembly was changed to the amount as shown in the below-mentioned Table 10.

### Examples 40 to 43

Membrane electrode assemblies according to the present invention and polymer electrolyte fuel cells of the present invention having the same configuration as that of Example 1 were fabricated, except that an aqueous solution containing Ca ions was used in place of the aqueous solution containing Fe ions, and the polymer electrolyte membrane of the membrane electrode assembly was caused to carry Ca ions in an amount as shown in the below-mentioned Table 11.

### Comparative Examples 54 to 58

Membrane electrode assemblies and polymer electrolyte fuel cells having the same configuration as that of Example 1 were fabricated, except that the amount of Ca ions carried on the polymer electrolyte membrane of the membrane electrode assembly was changed to the amount as shown in the below-mentioned Table 11.

### Examples 44 to 47

Membrane electrode assemblies according to the present invention and polymer electrolyte fuel cells of the present invention having the same configuration as that of Example 1 were fabricated, except that an aqueous solution containing Al ions was used in place of the aqueous solution containing Fe ions, and the polymer electrolyte membrane of the membrane electrode assembly was caused to carry Al ions in an amount as shown in the below-mentioned Table 12.

### Comparative Examples 59 to 63

Membrane electrode assemblies and polymer electrolyte fuel cells having the same configuration as that of Example 1 were fabricated, except that the amount of Al ions carried on the polymer electrolyte membrane of the membrane electrode assembly was changed to the amount as shown in the below-mentioned Table 12.

### Comparative Example 64

A membrane electrode assembly and a polymer electrolyte fuel cell having the same configuration as that of Example 1 were fabricated, except that the polymer electrolyte membrane of the membrane electrode assembly was not caused to carry metal ions.

### Example 48

In this Example, a membrane electrode assembly according to the present invention and a polymer electrolyte fuel cell of the present invention having the same configuration as that of Example 1 were fabricated, except that an aqueous solution containing Ni ions was used in place of the aqueous solution containing Fe ions, the polymer electrolyte membrane of the membrane electrode assembly was caused to carry Ni ions in an amount equivalent to 10% of the ion exchange group capacity of the polymer electrolyte membrane, and the below-mentioned separator plate was used.

In this Example, the following preparatory experiment was carried out. Specifically, a gold-plated separator plate made of stainless steel (SUS 316) was prepared, and then a test piece was obtained by cutting the separator plate. The amount of metal ions eluted from the surface of the obtained test piece was measured. As a result, the amount of nickel ions eluted was 0.03 μg/day/cm² and the amount of iron ions eluted was 0.004 μg/day/cm².

On the basis of the result of this preparatory experiment, the area of the aforementioned separator plate was adjusted such that the amount of metal ions to be eluted from the entire area of the aforementioned separator plate was equivalent to 2% of the ion exchange group capacity of the polymer electrolyte membrane per 1000 hours. The polymer electrolyte fuel cell was fabricated using the separator plate obtained as mentioned above.

TABLE 1

| | | | Amount of | |
|---|---|---|---|---|
| | Type | | fluoride | Discharge |
| | of | Content | ions eluted | voltage |
| | metal | (%) | (μg/day/cm²) | (V) |
| Comparative Example 1 | Fe | 0.002 | 0.282 | 0.765 |
| Comparative Example 2 | Fe | 0.003 | 0.467 | 0.765 |
| Comparative Example 3 | Fe | 0.01 | 1.900 | 0.765 |
| Comparative Example 4 | Fe | 0.1 | 10.280 | 0.763 |
| Comparative Example 5 | Fe | 0.15 | 9.500 | 0.762 |
| Comparative Example 6 | Fe | 0.7 | 1.500 | 0.76 |
| Example 1 | Fe | 1.0 | 0.560 | 0.758 |
| Example 2 | Fe | 5.0 | 0.300 | 0.755 |
| Example 3 | Fe | 10.0 | 0.250 | 0.753 |
| Example 4 | Fe | 40.0 | 0.220 | 0.746 |
| Example 7 | Fe | 50.0 | 0.200 | 0.68 |

TABLE 2

| | | | Amount of |
|---|---|---|---|
| | Type of | Content | fluoride ions eluted |
| | metal | (%) | (μg/day/cm²) |
| Comparative Example 8 | Cu | 0.0027 | 0.300 |
| Comparative Example 9 | Cu | 0.014 | 1.120 |
| Comparative Example 10 | Cu | 0.062 | 2.400 |
| Comparative Example 11 | Cu | 0.3 | 2.140 |
| Example 5 | Cu | 1.0 | 0.400 |
| Example 6 | Cu | 7.0 | 0.180 |
| Example 7 | Cu | 15.0 | 0.180 |
| Example 8 | Cu | 40.0 | 0.170 |
| Comparative Example 12 | Cu | 45.0 | 0.170 |

TABLE 3

| | | | Amount of |
|---|---|---|---|
| | Type of | Content | fluoride ions eluted |
| | metal | (%) | (μg/day/cm²) |
| Comparative Example 13 | Mn | 0.004 | 0.300 |
| Comparative Example 14 | Mn | 0.014 | 0.800 |
| Comparative Example 15 | Mn | 0.098 | 1.600 |
| Comparative Example 16 | Mn | 0.3 | 1.470 |
| Example 9 | Mn | 1.0 | 0.230 |
| Example 10 | Mn | 7.0 | 0.180 |
| Example 11 | Mn | 15.0 | 0.180 |
| Example 12 | Mn | 40.0 | 0.170 |
| Comparative Example 17 | Mn | 45.0 | 0.170 |

TABLE 4

| | | | Amount of |
|---|---|---|---|
| | Type of | Content | fluoride ions eluted |
| | metal | (%) | (μg/day/cm²) |
| Comparative Example 18 | Cr | 0.004 | 0.100 |
| Comparative Example 19 | Cr | 0.012 | 0.250 |
| Comparative Example 20 | Cr | 0.098 | 0.920 |
| Comparative Example 21 | Cr | 0.5 | 0.360 |
| Example 13 | Cr | 1.0 | 0.150 |
| Example 14 | Cr | 4.1 | 0.180 |
| Example 15 | Cr | 12.0 | 0.180 |
| Example 16 | Cr | 40.0 | 0.170 |
| Comparative Example 22 | Cr | 56.0 | 0.170 |

TABLE 5

| | | | Amount of | |
|---|---|---|---|---|
| | Type | | fluoride | Discharge |
| | of | Content | ions eluted | voltage |
| | metal | (%) | (μg/day/cm²) | (V) |
| Comparative Example 23 | Ni | 0.0027 | 0.274 | 0.766 |
| Comparative Example 24 | Ni | 0.0079 | 0.489 | 0.764 |
| Comparative Example 25 | Ni | 0.062 | 0.870 | 0.764 |
| Comparative Example 26 | Ni | 0.17 | 0.830 | 0.762 |
| Example 17 | Ni | 1.1 | 0.260 | 0.757 |
| Example 18 | Ni | 7.0 | 0.170 | 0.753 |
| Example 19 | Ni | 15.0 | 0.179 | 0.752 |
| Example 20 | Ni | 40.0 | 0.160 | 0.740 |
| Comparative Example 27 | Ni | 49.0 | 0.179 | 0.530 |

TABLE 6

| | | | Amount of |
|---|---|---|---|
| | Type of | Content | fluoride ions eluted |
| | metal | (%) | (μg/day/cm²) |
| Comparative Example 28 | Mo | 0.004 | 0.200 |
| Comparative Example 29 | Mo | 0.011 | 0.380 |
| Comparative Example 30 | Mo | 0.06 | 0.750 |
| Comparative Example 31 | Mo | 0.3 | 0.650 |
| Example 21 | Mo | 1.0 | 0.215 |
| Example 22 | Mo | 7.0 | 0.120 |
| Example 23 | Mo | 15.0 | 0.108 |
| Example 24 | Mo | 40.0 | 0.108 |
| Comparative Example 32 | Mo | 68.0 | 0.080 |

TABLE 7

| | | | Amount of |
|---|---|---|---|
| | Type of | Content | fluoride ions eluted |
| | metal | (%) | (μg/day/cm²) |
| Comparative Example 33 | Ti | 0.0026 | 0.100 |
| Comparative Example 34 | Ti | 0.0091 | 0.250 |
| Comparative Example 35 | Ti | 0.098 | 0.450 |
| Comparative Example 36 | Ti | 0.5 | 0.332 |
| Example 25 | Ti | 1.2 | 0.120 |
| Example 26 | Ti | 4.1 | 0.080 |
| Example 27 | Ti | 12.0 | 0.072 |
| Example 28 | Ti | 40.0 | 0.063 |
| Comparative Example 37 | Ti | 68.0 | 0.054 |

TABLE 8

| | | | Amount of |
|---|---|---|---|
| | Type of | Content | fluoride ions eluted |
| | metal | (%) | (μg/day/cm²) |
| Comparative Example 38 | Na | 0.003 | 0.467 |
| Comparative Example 39 | Na | 0.01 | 0.498 |
| Comparative Example 40 | Na | 0.055 | 0.514 |
| Comparative Example 41 | Na | 0.15 | 0.487 |
| Comparative Example 42 | Na | 0.9 | 0.409 |
| Example 29 | Na | 5.0 | 0.325 |
| Example 30 | Na | 20.0 | 0.250 |
| Example 31 | Na | 39.0 | 0.220 |
| Comparative Example 43 | Na | 89.0 | 0.200 |

TABLE 9

| | | | Amount of |
|---|---|---|---|
| | Type of | Content | fluoride ions eluted |
| | metal | (%) | (μg/day/cm²) |
| Comparative Example 44 | K | 0.0027 | 0.360 |
| Comparative Example 45 | K | 0.014 | 0.385 |
| Comparative Example 46 | K | 0.062 | 0.367 |
| Comparative Example 47 | K | 0.3 | 0.373 |
| Example 32 | K | 1.0 | 0.284 |
| Example 33 | K | 7.0 | 0.126 |
| Example 34 | K | 15.0 | 0.126 |
| Example 35 | K | 40.0 | 0.112 |
| Comparative Example 48 | K | 67.0 | 0.122 |

TABLE 10

| | | | Amount of |
|---|---|---|---|
| | Type of | Content | fluoride ions eluted |
| | metal | (%) | (μg/day/cm²) |
| Comparative Example 49 | Mg | 0.0027 | 0.300 |
| Comparative Example 50 | Mg | 0.022 | 0.348 |
| Comparative Example 51 | Mg | 0.062 | 0.337 |
| Comparative Example 52 | Mg | 0.2 | 0.326 |
| Example 36 | Mg | 1.2 | 0.235 |
| Example 37 | Mg | 7.0 | 0.171 |
| Example 38 | Mg | 15.0 | 0.139 |
| Example 39 | Mg | 40.0 | 0.144 |
| Comparative Example 53 | Mg | 74.0 | 0.134 |

TABLE 11

| | | | Amount of |
|---|---|---|---|
| | Type of | Content | fluoride ions eluted |
| | metal | (%) | (μg/day/cm²) |
| Comparative Example 54 | Ca | 0.004 | 0.300 |
| Comparative Example 55 | Ca | 0.014 | 0.325 |
| Comparative Example 56 | Ca | 0.098 | 0.313 |
| Comparative Example 57 | Ca | 0.3 | 0.280 |
| Example 40 | Ca | 1.3 | 0.157 |
| Example 41 | Ca | 7.0 | 0.132 |
| Example 42 | Ca | 15.0 | 0.180 |
| Example 43 | Ca | 39.0 | 0.170 |
| Comparative Example 58 | Ca | 59.0 | 0.170 |

TABLE 12

| | | | Amount of |
|---|---|---|---|
| | Type of | Content | fluoride ions eluted |
| | metal | (%) | (μg/day/cm²) |
| Comparative Example 59 | Al | 0.004 | 0.187 |
| Comparative Example 60 | Al | 0.018 | 0.205 |
| Comparative Example 61 | Al | 0.098 | 0.235 |
| Comparative Example 62 | Al | 0.34 | 0.211 |
| Example 44 | Al | 1.0 | 0.108 |
| Example 45 | Al | 4.1 | 0.102 |
| Example 46 | Al | 12.0 | 0.072 |
| Example 47 | Al | 40.0 | 0.054 |
| Comparative Example 63 | Al | 56.0 | 0.040 |

[Evaluation Test 1]

The amounts of fluoride ions eluted from the polymer electrolyte fuel cells of Examples 1 to 47 and Comparative Examples 1 to 64 were evaluated. The polymer electrolyte fuel cells of Examples 1 to 47 and Comparative Examples 1 to 64 were subjected to a discharge test, in which hydrogen as a fuel gas and air as an oxidant gas were supplied to each electrode under the conditions that the cell temperature was 70° C., the fuel gas utilization rate (Uf) was 70% and the air utilization rate (Uo) was 40%. Herein, the fuel gas and the air were humidified until each of them had a dew point of 65° C. and then supplied.

While being continuously supplied with the air and the fuel gas, the cells were continuously operated at a current density of 200 mA/cm². When the voltages were stabilized after 300 hours has passed since the start of electric power generation, the amounts of fluoride ions contained in the exhaust gas and the drain water were quantified by ion chromatography (IA-100 Ion Analyzer available from DKK-TOA Corporation).

More specifically, with respect to each Example and Comparative Example, five polymer electrolyte fuel cells were used. The cells were operated for 500 hours after their voltages were stabilized (that is, after 300 hours has passed since the start of power generation) to determine a mean amount of fluoride ions eluted. The amount of fluoride ions eluted is shown in the above Tables 1 to 12 as a mean value of the measured values obtained using the five polymer electrolyte fuel cells.

Herein, as a result of the preparatory experiment, it was observed that there was a good correlation between the accumulated amount of fluoride ions discharged to the drain water and the decreased thickness of the polymer electrolyte membrane. The accumulated amount was therefore used as an index for judging a degree of decomposition of the polymer electrolyte membrane.

As is evident from Tables 1 to 12, whichever type of metal ion was caused to be carried, when the carried amount was small, the amount of fluoride ions eluted tended to increase as the carried amount was increased. This is because radicals were produced from hydrogen peroxide that generated during an electrode reaction using these metal ions as a catalyst, and as a result, the polymer electrolyte membrane was decomposed. However, when the carried amount of metal ions was close to 0.1%, the amount of fluoride ions eluted started to decrease; and when the carried amount was not less than 1.0%, the eluted amount was equivalent or less to that of Comparative Example 64 (0.2 μg/day/cm²) in which metal ions were not added. Conceivably, this is because presence of a large amount of metal ions caused the metal ions to act as a catalyst for decomposing radicals, and as a result, decomposition of the polymer electrolyte membrane was suppressed.

In addition, in the case where metal ions having a stable valence such as Na ions, K ions, Ca ions, Mg ions or Al ions were caused to be carried, the amount of fluoride ions eluted was not significantly increased even when the carried amount was increased. Therefore, it is conceivable that the catalyst effect for decomposing hydrogen peroxide to generate radicals is small in these metal ions. However, as the carried amount of Na ions, K ions, Ca ions, Mg ions or Al ions were further increased, the amount of fluoride ions eluted was decreased as in the case of Fe ions, Cu ions, Cr ions, Ni ions, Mo ions, Ti ions or Mn ions. Conceivably, this is because when these metal ions are substituted for protons, the size of a cluster to be composed of the hydrophilic ion exchange group in the polymer electrolyte membrane decreases and the water content drops, and the portion that is susceptible to attack in the polymer electrolyte membrane is protected by this effect, and thereby resistance to decomposition of the polymer electrolyte membrane is improved.

As mentioned above, from the results of Evaluation Test 1 as shown in Tables 1 to 12, it was confirmed that in the present invention, allowing metal ions, which are stable in an aqueous solution, to be carried in the inside of the membrane electrode assembly in an amount equivalent to 1.0 to 40.0% of the ion exchange group capacity of the polymer electrolyte membrane is preferable.

[Evaluation Test 2]

The discharge voltages of the polymer electrolyte fuel cells of Examples 1 to 4 and Comparative Examples 1 to 7 (the cells comprising a membrane electrode assembly carrying Fe ions) and the polymer electrolyte fuel cells of Examples 17 to 20 and Comparative Examples 23 to 27 (the cells comprising a membrane electrode assembly carrying Ni ions) were measured. The polymer electrolyte fuel cells of Examples 1 to 4 and Examples 17 to 20 and the polymer electrolyte fuel cells of Comparative Examples 1 to 7 and Comparative Examples 23 to 27 were subjected to a discharge test, in which hydrogen as a fuel gas and air as an oxidant gas were supplied to each electrode thereof under the conditions that the cell temperature was 70° C., the fuel gas utilization rate (Uf) was 70% and the air utilization rate (Uo) was 40%. Herein, the fuel gas and the air were humidified until each of them had a dew point of 65° C. and then supplied.

While being continuously supplied with the air and the fuel gas, the cells were continuously operated at a current density of 200 mA/cm². The cell voltages (discharge voltage) after 300 hours has passed since the start of power generation were measured. The results are shown in Tables 1 and 5.

As is evident from Tables 1 and 5, when the carried amount of Fe ions or Ni ions was in the range from 1.0 to 40.0%, a decrease in cell voltage was hardly observed; however, when it exceeded 40.0%, a sharp decrease was observed. Conceivably, this is because when the amount exceeded 40.0%, Fe ions or Ni ions trapped the ion exchange group in the polymer electrolyte membrane, impaired the continuity of the ion exchange group that contributes to proton conductivity, and thus caused a great reduction in ion conductivity of the polymer electrolyte membrane.

As mentioned above, from the results of Evaluation Test 2 as shown in Tables 1 and 5, it was confirmed that in the present invention, allowing Fe ions or Ni ions to be carried in the inside of the membrane electrode assembly in an amount equivalent to 1.0 to 40.0% of the ion exchange group capacity of the polymer electrolyte membrane is preferable. Moreover, from these results, it was suggested that even in the case of metal ions other than Fe ions, which are stable in an aqueous solution, allowing the metal ions to be carried in the inside of the membrane electrode assembly in an amount equivalent to 1.0 to 40.0% of the ion exchange group capacity of the polymer electrolyte membrane is preferable.

[Evaluation Test 3]

The polymer electrolyte fuel cell of Example 2 (the cell comprising a membrane electrode assembly carrying Fe ions in an amount of 5.0%) was used to fabricate a fuel cell system of the present invention having a configuration as illustrated in FIG. 3, with which an examination of externally supplying metal ions was conducted. In other words, it was examined whether retaining the amount of metal ions contained in the membrane electrode assembly can suppress decomposition and degradation of the polymer electrolyte membrane and maintain cell performance of the polymer electrolyte fuel cell over a long period of time (long time duration test). Herein, the polymer electrolyte fuel cell 31 was constituted of one unit cell, and was provided with the Fe ion tank 34a and the Fe ion tank 34b serving as the metal ion supplying means.

In order to supply Fe ions to the membrane electrode assembly, an aqueous solution containing Fe ions was added by dropping from a gas inlet of the polymer electrolyte fuel cell 31. As the aqueous solution containing Fe ions, a 0.001 M aqueous solution of ferrous (II) sulfate was used. The 0.001 M aqueous solution of ferrous (II) sulfate containing iron ions in an amount equivalent to 0.2% of the ion exchange group capacity of the polymer electrolyte membrane was added (fed) by dropping every 2000 hours. A portion from which the solution was added by dropping was located in the downstream of the fuel gas controller 33 and the oxidant gas controller 32 of the fuel cell system as illustrated in FIG. 3.

The Fe ions were supplied from the Fe ion tank 34a in the fuel electrode side or the Fe ion tank 34b in the air electrode side. The amount of fluoride ions in drain water after 5000 hour operation was measured in the same manner as in the aforementioned Evaluation Test 1.

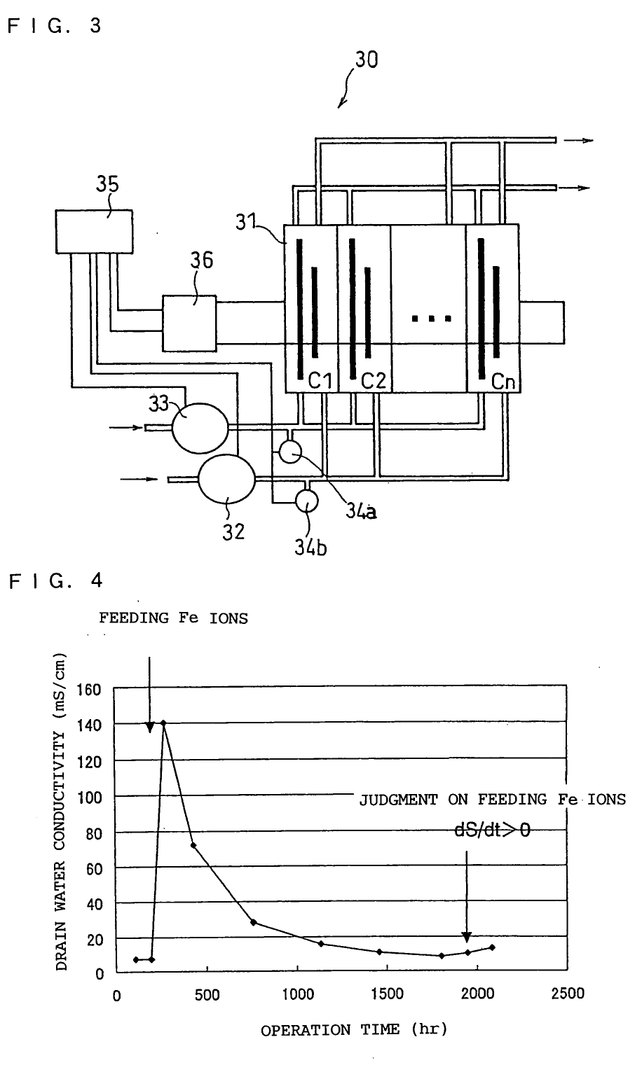

Herein, a preparatory experiment was carried out to determine the timing of feeding Fe ions (every 2000 hours) as mentioned below. That is, the electrical conductivity of the drain water discharged from the polymer electrolyte fuel cell 31 was measured. As shown in FIG. 4, immediately after the solution containing Fe ions was fed, the electrical conductivity of the drain water increased due to the influence of the hydrogen ions and the like that were discharged when Fe ions were substituted for the hydrogen ions in the polymer electrolyte membrane. Thereafter, the electrical conductivity decreased gradually; however, when decomposition of the polymer electrolyte membrane occurred due to the decrease in Fe ion concentration, the electrical conductivity started to increase again. In view of this, a differential value of the electrical conductivity to time was calculated and the time when this differential value changed from negative to positive was judged using the controller 35. It was thus decided that the aqueous solution containing Fe ions be additionally fed to the polymer electrolyte fuel cell 31 every 2000 hours.

As a result, in the fuel cell system of Example 3 (the system comprising a membrane electrode assembly carrying Fe ions in an amount of 10.0%), in the case where the aqueous solution containing Fe ions was supplied from the fuel electrode side, the amount of Fe ions in the membrane electrode assembly was 9.7%, and no significant decrease was observed. In contrast, in the case where the aqueous solution containing Fe ions was supplied from the air electrode side, the amount of Fe ions in the membrane electrode assembly was 7.2%.

Conceivably, this is because since Fe ions are positive ions like hydrogen ions and flow from the fuel electrode to the air electrode when the cell is in a power generating state, the Fe ions are smoothly captured in the polymer electrolyte membrane when supplied to the fuel electrode; however, when supplied to the air electrode, the Fe ions enter in the direction opposing to the flow of hydrogen ions; and as result, the amount of Fe ions uncaptured in the polymer electrolyte membrane and discharged to the outside is increased. It was confirmed accordingly that in supplying metal ions, it is more efficient to supply the metal ions to the polymer electrolyte membrane from the fuel electrode side.

As mentioned above, it was confirmed that by adding Fe ions to the polymer electrolyte fuel cell 31 of the present invention at a good timing, a constant amount of Fe ions can be carried on the membrane electrode assembly, decomposition and degradation of the polymer electrolyte membrane can be sufficiently suppressed over a long period of time notwithstanding repeated start and stop of the operation, reduction in initial properties of the polymer electrolyte fuel cell can be prevented sufficiently, and thus the cell can exert an excellent durability. Moreover, from these results, it was suggested that even in the case of metal ions other than Fe ions, which are stable in an aqueous solution, allowing the metal ions to be carried in the inside of the membrane electrode assembly in an amount equivalent to 1.0 to 40.0% of the ion exchange group capacity of the polymer electrolyte membrane is preferable.

[Evaluation Test 4]

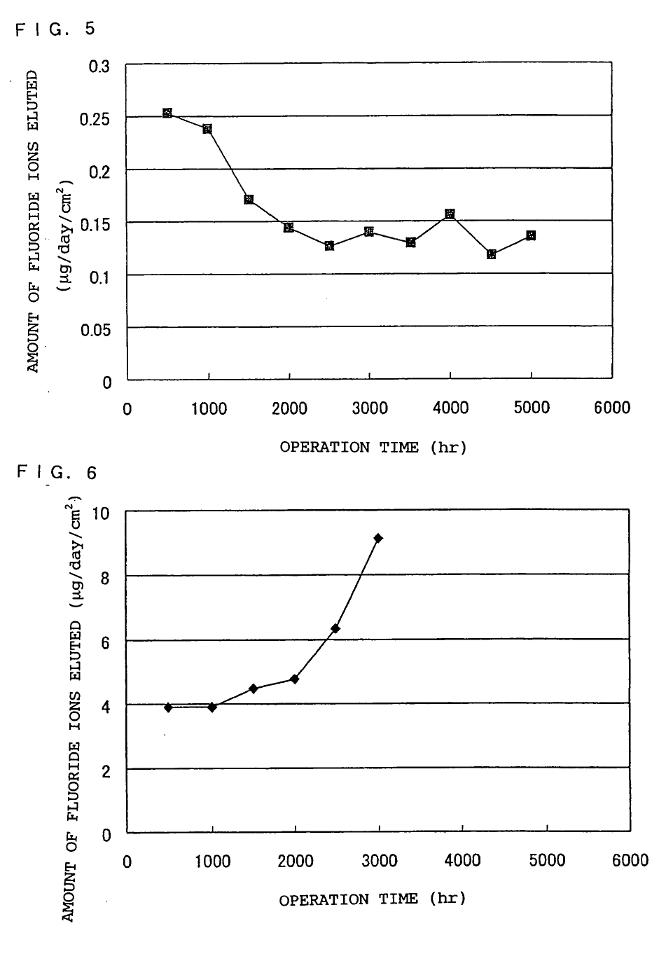

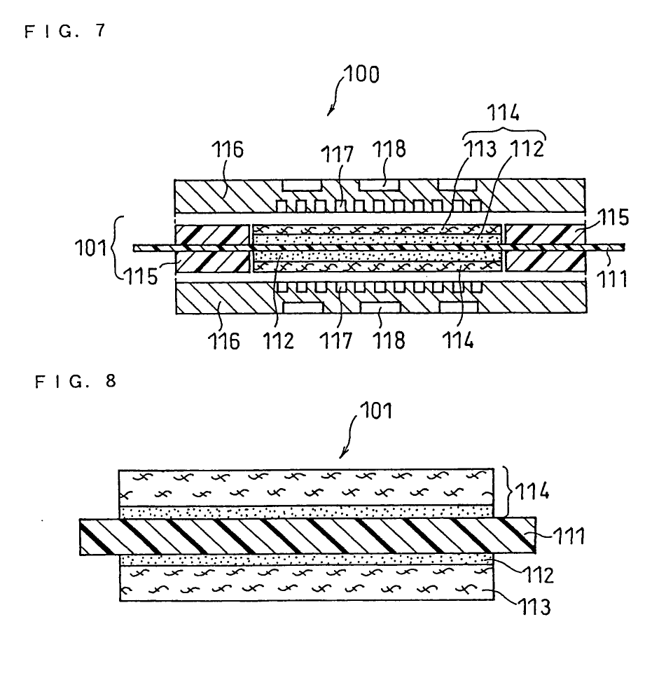

The polymer electrolyte fuel cell of Example 3 (the cell comprising a membrane electrode assembly carrying Fe ions in an amount of 10.0%) and the polymer electrolyte fuel cell of Comparative Example 6 (the cell comprising a membrane electrode assembly carrying Fe ions in an amount of 7.0%) were used to fabricate fuel cell systems of the present invention each having a structure as illustrated in FIG. 3, which were then subjected to a continuous operation over a long period of time. And during the continuous operation, the amounts of fluoride ions contained in the drain water were measured in the same manner as in the Evaluation Test 1. The measurement results, that is, the relations between the operation time and the amount of fluoride ions eluted are shown in FIGS. 5 and 6. At this time, the cell voltages were also measured.

As is evident from FIG. 5, in the polymer electrolyte fuel cell of Example 3, the amount of fluoride ions eluted was small even after 5000 hours has passed, and a reduction in the cell voltage was as small as 3% compared with the initial voltage. In contrast, as is evident from Table 6, in the polymer electrolyte fuel cell of Comparative Example 6, the eluted amount of fluoride ions was tended to increase gradually after approximately 2000 hours has passed, and when 3000 hours has passed, the cell voltage dropped close to 0 V, and the operation was disabled.

As mentioned above, it was confirmed that with respect to the amount of Fe ions to be carried in the membrane electrode assembly in the present invention, the amount is equivalent to less than 1.0% of the ion exchange group capacity of the polymer electrolyte membrane is insufficient. Moreover, from the results above, it was suggested that in the case of metal ions other than Fe ions, which are stable in an aqueous solution, the amount equivalent to less than 1.0% of the ion exchange group capacity of the polymer electrolyte membrane is insufficient to cause the metal ions to be carried in the inside of the membrane electrode assembly.

[Evaluation Test 5]

The polymer electrolyte fuel cell of Example 48 (the cell comprising a membrane electrode assembly carrying Ni ions in an amount of 10.0% and a separator plate made of metal) was used to produce a fuel cell system of the present invention having a structure as illustrated in FIG. 3, which was then subjected to a continuous operation over a long period of time.

In this fuel cell system, after the operation of the polymer electrolyte fuel cell for 2000 hours, the membrane electrode assembly was disassembled and the amount of metal ions carried therein was measured. As a result, 12.3% of metal ions were detected. The metal ions that were mainly detected from the inside of the membrane electrode assembly were Ni ions, Fe ions and Cr ions. The amount of metal ions carried in the membrane electrode assembly has increased conceivably because the elution rate of the metal ions from the separator plate is high at an early stage of power generation.

As mentioned above, it was confirmed that even when a separator plate made of metal was used as the metal ion supplying means, the amount of metal ions being carried in the membrane electrode assembly can be maintained at a constant level, and thus a polymer electrolyte fuel cell excellent in durability can be obtained.

### INDUSTRIAL APPLICABILITY

Since the fuel cell system of the present invention can suppress decomposition and deterioration over a long period of time of the polymer electrolyte membrane caused by radicals or hydrogen peroxide produced in the electrode, the fuel cell system of the present invention is preferably applicable to applications for which such an excellent durability is required that the initial performance is not reduced and the cell performance is not degraded notwithstanding repeated start and stop of the operation, such as stationary cogeneration systems, electric cars, and the like.

1. A fuel cell system including a polymer electrolyte fuel cell comprising: a membrane electrode assembly including a polymer electrolyte membrane with hydrogen ion conductivity, and a fuel electrode and an oxidant electrode sandwiching said polymer electrolyte membrane therebetween; a first separator plate for supplying and discharging a fuel gas to and from said fuel electrode; and a second separator plate for supplying and discharging an oxidant gas to and from aid fuel electrode, characterized in that
said system comprises a metal ion supplying means for supplying metal ions, which are stable in an aqueous solution, to said membrane electrode assembly such that said membrane electrode assembly contains said metal ions in an amount equivalent to 1.0 to 40.0% of the ion exchange group capacity of said polymer electrolyte membrane.

2. The fuel cell system in accordance with claim 1, characterized in that
said metal ion supplying means supplies said metal ions to said membrane electrode assembly such that said membrane electrode assembly contains said metal ions in an amount equivalent to 10.0 to 40.0% of the ion exchange group capacity of said polymer electrolyte membrane.

3. The fuel cell system in accordance with claim 1, characterized in that the ion exchange group capacity of said polymer electrolyte membrane is 0.5 to 1.5 meq/g.

4. The fuel cell system in accordance with claim 1, characterized in that said metal ions are at least one selected from a group consisting of iron ions, cupper ions, chromium ions, nickel ions, molybdenum ions, titanium ions and manganese ions.

5. The fuel cell system in accordance with claim 4, characterized in that said iron ions include Fe²⁺.

6. The fuel cell system in accordance with claim 1, characterized in that said metal ions are at least one selected from a group consisting of sodium ions, potassium ions, calcium ions, magnesium ions and aluminum ions.

7. The fuel cell system in accordance with claim 1, characterized in that said metal ion supplying means is configured such that said metal ion supplying means supplies said metal ions to said membrane electrode assembly at least from said fuel electrode side.

8. The fuel cell system in accordance with claim 1, characterized in that said metal ion supplying means is configured such that said metal ion supplying means supplies an aqueous solution containing said metal ions.

9. The fuel cell system in accordance with claim 1, characterized in that said metal ion supplying means is a metal ion generating member for generating said metal ions by a chemical reaction.
